(19) United States
(12) Patent Application Publication
(10) Pub. No.: US 2019/0239987 A1
(43) Pub. Date: Aug. 8, 2019

(54) DENTAL APPLIANCE AND METHOD FOR MAKING

(71) Applicant: Mobile Imaging Solutions, Richmond, VA (US)

(72) Inventors: Perry E. JONES, Richmond, VA (US); Ryan JONES, Richmond, VA (US); Michael JONES, Richmond, VA (US)

(73) Assignee: Mobile Imaging Solutions, Richmond, VA (US)

(21) Appl. No.: 16/039,814

(22) Filed: Jul. 19, 2018

Related U.S. Application Data
(60) Provisional application No. 62/625,586, filed on Feb. 2, 2018.

(51) Int. Cl. A61C 9/00; A61C 7/08; A61C 7/00

(52) U.S. Cl. CPC A61C 9/0053; A61C 7/002; A61C 7/08

(57) ABSTRACT

The current invention relates to the creation of a dental device from a dental scan without a mode.

### BACKGROUND

About 65% of US population has lower anterior crowding (crowding of the lower incisors) and about 75% of this population would benefit from tooth movement. Additionally, about 80% of the population has less than ideal occlusion. Of these cases, about 85% are not severe and can be easily treated.

Of the cases above, general practitioners treat more cases than orthodontists using products like, for example, INVISALIGN® (dental realignment device). However, 85%-95% of treated patients will experience post tooth movement relapse unless a retainer is used.

Retainers are currently predominantly produced by labs and third parties. This is at least partially because efforts to produce retainers in-house are time consuming and inconsistent. Labs produce more consistent results but are more expensive and require at least a full day to provide the product.

The most common technique used to produce dental appliances is a multi-step process that includes, creation of a model (stone, 3D printed, urethane etc) by impression or digital scan. A thermoplastic material is heated and using either a vacuum machine or a press-down machine the thermoplastic is formed over the “model.” Additional steps include removal of the thermoplastic material from the model, course trimming of the material, fine trimming of the gingival margin, polishing, and finish of the appliance. There are other techniques also requiring multiple steps using materials such as stainless steel wires and acrylic. Each of these techniques require multiple steps and the manufacturing process does not directly produce the “end use” product.

The traditional appliance manufacture process is time consuming. The step to produce a physical model slows the appliance manufacture process. Accuracy also suffers when the appliance must be constructed on a model vs made directly.

Digital solutions include additive manufacturing such as 3D printing. These systems can be messy, with unwanted odors, and multiple layers of processing for the end use product. Pressure washing of support material, isopropyl alcohol soaking, etc. are a few examples of such additional steps.

Finally, traditional gypsum/stone models require specific directions for use that are often not followed properly by technicians. Stone models are fragile and designed for single use.

Therefore, there is a need for the ability to produce retainers in-house quickly, cheaply, and consistently using a device which is easy to install and operate. The invention of the current application provides such advantages.

### SUMMARY OF THE INVENTION

The invention of the current application is a method for making a retainer appliance and the like, for example, mouth guards, sleep appliances, surgical guides for implant placement, and any other plastic dental appliance, without the need of a model.

The basic workflow requires a digital representation of the surface morphology of the teeth in each arch intended to support the dental appliance. A preferred embodiment of this application regards a retainer type appliance made to help reduce unwanted tooth movement following tooth movement treatment of any kind.

The method for making the retainer appliance and the like includes scanning the patients' teeth to capture its surface morphology via, for example, an intraoral digital scan. Digital data to represent the surface morphology can be presented in different formats. There are many already existing machines that can be used in the scanning process. These include, for example, the ITERO® ELEMENT®, CEREC®, 3SHAPE TRIOS®, and CARESTEAM®. The intraoral digital scan process can be performed by various machines. These machines can be used to scan the surface morphology of a patient's teeth directly, or can be used to scan a physical model produced from an impression of the patient's teeth. In either instance, the end product is a .stl file.

Stl means standard tessellation language. STL (stereolithography”) is a file format for stereolithography CAD software created by 3D Systems. The term “.stl files” as used herein refers to any digital file that describes only the surface geometry of three-dimensional objects without any color, texture or other common CAD model attributes. In the preferred embodiment, a conventional STL file format is used exclusively. Acquisition of digital data may include intraoral digital scan data, Computed Tomography (CT), Cone Beam Computed Tomography (CBCT), taken directly or from CT or CBCT scanning of direct impression or scans of physical models representing the patient's teeth. In the preferred embodiment, the surface data acquisition is made with an intraoral optical digital scanner. This data is referred to herein as the “initial stl file.”

The initial .stl file is imported and modified using software which is used to “repair” the surface data and segment or slice the unwanted data to provide a “repaired .stl file” which can be prior to creating an accurate “rendering” that can be seen and manipulated on a computer screen. In some embodiments, the “repair” comprises smoothing of rough surfaces and filling in gaps automatically. In other embodiments, the “repair” comprises smoothing of rough surfaces and filling in gaps manually through user guidance, typically with the aid of an accurate “rendering” on a computer screen. In further embodiments, the “repair” comprises smoothing of rough surfaces and filling in gaps automatically and manually. An “initial .stl file” preferably is a replica of the surface that is mapped digitally during the intra oral digital scan. That replica is comprised of small triangles which are oriented together to conform to the surface that is scanned. Sometimes the triangles are oriented in a way that leaves gaps or holes between them. Void areas can cause inaccurate milling of the end product. Repairing the surface is a process used to fill in the gaps or void areas to provide a “repaired .stl file”. Embodiments which provide for “repair” of the surface will automatically detect gaps between the triangles within the .stl file and fill them. Embodiments of his invention include processes wherein the repairs are done manually by the user, typically with the aid of a rendering of the .stl file on a computer screen. The user can view the “initial .stl file”, locate gaps, select them, and fill. Additionally, gaps can be detected when the triangles are not oriented correctly and/or do not fit together perfectly which leaves gaps in the file. In other embodiments of this invention, the process provides for both automatic and manual repairs to provide a “repaired .stl file”. The “repaired .stl file” is a digital model which can optionally be represented virtually on a computer screen.

Following the “repair” of the “initial stl file”, this data is translated to create a “surface re-topography” file. A “surface re-topography .stl file,” as defined herein, is an .stl file of a surface map of the morphology of the entire tooth surface and surrounding soft tissue with a specific thickness and perimeter. This surface map is an actual overlay on top of the digital model (“repaired .stl file”) with a thickness and perimeter margin defined. This is a first step in digitally designing the end use product. In some embodiments, the user is able select a desired thickness from a range of 0.1 mm to 3.0 mm. In the preferred embodiment the thickness is about 0.3 mm.

The surface re-topography .stl file can provide a virtual representation of the overlay. The surface re-topography .stl file is then preferably modified so that the overlay does not over engage curved surface undercuts. These modifications can be made automatically, manually or a combination of both. This overlay, with thickness and margin defined, can be virtually shown on top of the virtual digital model generated by the repaired .stl file on the computer screen to aid manual modifications. The virtual images of the overlay can be generated automatically or by the user from the surface re-topography .stl file. The margin may optionally be adjusted by the operator. The operator may also manually move points along the margin line to trim the actual margin to his/her liking. In a preferred embodiment, the software or user manually identify the tooth surface height of contour and identify undercuts for retention and block out excessive undercut areas. This is done, for example, by selecting and dragging points along the margin of the overlay. Once modifications are complete, the modified surface re-topography .stl file can be exported to the appropriate device to generate a retainer appliance and the like, for example, mouth guards, sleep appliances, surgical guides for implant placement, and other plastic dental appliances.

A user interface allows the user to import and export STL files and to approve and export the designed dental appliance (modified surface re-topography .stl file) to a Galvanometer Milling Machine (a milling machine incorporating a galvanometer to, for example, guide a laser) as an STL file.

The modified surface re-topography .stl file essentially defines the overlay which is the final end use product. The overlay can be virtually represented on the computer from the modified surface re-topography .stl file. The end use product can therefore be seen on the computer screen as the overlay and is the shape that will be milled by the machine.

In some embodiments the process of the present invention operates using the following steps:

1. Importing the initial .stl file of a digital model, preferably from a scan.
2. Automatically and or manually repairing of the digital model through automatic or manual repairs of the initial .stl file, including trimming as needed, to generate a “repaired .stl file.”
3. Translating the “repaired .stl file” and providing a thickness (preferably about 0.3 mm) and perimeter to create a “surface re-topography .stl file,” which is an overlay of occlusal/buccal/lingual surfaces.
4. Automatically and/or manually modifying the shape of the overlay as needed by automatically and/or manually modifying the “surface re-topography .stl file,”
4. Orienting the overlay to the path of insertion in the mouth while blocking out interferences and allowing for manual adjustment as needed.
5. Exporting the “modified surface re-topography .stl file” to the production device.

The completed “modified surface re-topography .stl file” may be exported to a device which can directly create the dental device. For example, the file may be transferred to a 3D printer where the dental device is printed directly from the “modified surface re-topography .stl file”.

### Example 1

In the preferred embodiment, the software maybe operated, for example, as undergoing a combination of the below steps. It should be understood that the words in quotes are used for descriptive purposes and that all steps are not mandatory in every embodiment:
1. Following Login, enter patient name and chart number
2. Select, for example, “add arch scan”
3. Select, for example, “choose file”
4. Select file to be imported into RetainerMaker
5. Select, for example, “maxillary arch” or “mandibular arch”
6. Select, for example, “save”
7. Select, for example, “new project”
8. Select the dropdown arrow next to, for example, “Arch Scan File”
9. Select the desired arch scan from the .stl files listed
10. Select the dropdown arrow next to, for example, “product type”
11. Select, for example, “Retainer” or “Night Guard”
12. Select desired appliance thickness by moving the point across the product thickness scale

Steps 1-12 can be optionally repeated if a mandiblular and maxillary appliance are being created within the same project
13. Set the margin by selecting points along the surface of the model (points are set by right clicking on a mouse, points are deleted by selecting the delete point icon and right clicking on a point, points can be moved by left clicking on a point and dragging to the desired location)(the model is rotated on 3D axis by left clicking on the model and moving the mouse in any direction, the model can be dragged by right clicking on the model and moving in any direction, the model can be enlarged or reduced by moving the mouse wheel forward or backward)(There may be a toolbar on to the right of the model that can be used to rotate, drag, enlarge, reduce, or center the model by clicking the appropriate button within the toolbar)(The user has the option to select the “redo” or “undo” arrows to redo or undo any action)(The settings icon can be selected at any time to change the type of appliance or the appliance thickness)
14. Select, for example, “Make” to generate “surface re-topography .stl file”
15. Review the retainer overlay on top of the model
16. Adjust margin points, if necessary, using the method described in step #12 to create a “modified surface re-topography .stl file”
17. Select the, for example, “transparency” icon to adjust the transparency of the model or the retainer (move the pointer across the model scale to adjust transparency of model/move pointer across the retainer/nightguard scale to adjust transparency of retainer/nightguard)
18, Select, for example, “Download”

Select, for example, “mandile” or “maxilla” and repeat steps 18-23 12-17 if creating an appliance for both arches in one project.
19. The designed retainer file can be retrieved from the browser's download folder. The RetainerMaker software process is now complete

Projects generated in RetainerMaker can be edited by clicking “edit” next to the product and using the controls described in steps #19 and 23.

In the preferred embodiment user input is required for:

1. adding patient info to associate with the device being made;
2. importing the digital model (scan STL) of the patient into the software;
3. creating a new project and selecting the scan STL upon which a device will be made;
4. selecting the type of device and thickness of the device. For example, the user can select either Retainer or Night Guard. The user can then select a specific thickness to be applied to the selected device type;
5. selecting a margin along the digital model to determine the boundary of the device;
6. instructing the software to generate the retainer or scan mesh and place it on top of the digital model which is a scan mesh.
7. correcting errors in the digital model and overlay.
8. exporting the generated design STL file of the dental device to be manufactured to a suitable manufacturing device.

In some embodiments the STL file is exported to a galvanometer guided laser milling machine (GGLM) which is used to mill the direct use dental appliance. The machine uses a multi axis galvanometer and mirrors to guide the laser along the appliance build material surface. The Galvanometer Guided Laser Milling Machine design comprises a galvanometer, laser, axis mounted mirrors, microprocessor to translate STL files, and carbon filter ventilation. The machine will be framed inside of a suitable enclosure. The enclosure will house the laser, multi axis mirrors, galvanometer, build cradle to hold appliance material, microprocessor, and necessary electronics and wiring.

In the preferred embodiment, the 3D printer or Galvanometer Guided Laser Milling is used to directly mill or create 3 dimensional objects, specifically dental appliances. This is a divergence from the prior art Galvanometer Guided Laser Milling which are only used to straight line cut substrate along a 2 dimensional surface for cutting or etching materials. Furthermore, in the dental industry, there is no machine using galvanometer guided lasers to remove substrate to directly create a dental appliance. The prior art either uses additive manufacture by way of 3D printing or subtractive manufacturing through CNC milling. CNC process is similar in that the appliance is milled. However, CNC does not use lasers to remove substrate. CNC uses a guided rotating burr to remove substrate.

In some embodiments, the Galvanometer Guided Laser Milling machine is a fixed laser and mirror design. In some embodiments, the Galvanometer Guided Laser Milling machine includes a rotating laser and a fixed substrate. In some embodiments, the Galvanometer Guided Laser Milling machine includes a rotating motor to move the substrate at specific intervals to allow the beam to cut along a 360 degree plane. There are many different ways to secure the substrate for milling.

In some embodiments, the Galvanometer Guided Laser Milling machine includes a sensor that will scan the surface of the substrate during the milling process. The sensor will compare the dental appliance to the .stl design file to insure accurate milling. If the milling process is flawed, the system will stop. This feature allows users to conserve material and to improve time management by not having to check the mill periodically. The prior art systems used to direct manufacture dental appliances such as 3D printing and CNC milling do not include this feature. This results in waste of extremely expensive build material.

In some embodiments, the material used for the GGLM is designed to a specific horse shoe shape to reduce substrate material waste and to reduce manufacture time.

The use of a Galvanometer Guided Laser Milling or 3D printer in combination with the software's conversion of the oral scan data, eliminates the need for physical models. For example, a plastic material (blank) is loaded into the GGLM, and the material is milled to specifications of the STL design file, or the dental device is directly printed from the 3D printer using an acceptable polymer material or combination of polymer material. Acceptable polymer material being defined a material suitable for use in a human mouth. Thus, a dental appliance is directly and accurately produced.

A Galvanometer Guided Laser Milling and a 3D printer is capable of manufacturing dental appliances in less time than most existing technologies. These devices are compact and suitable for in-office use. The materials used are easy to dispose of, safe to handle, odorless. The appliance design process is streamlined and requires minimal technical knowledge to operate.

Operation of the Galvanometer Guided Laser Milling machine would, for example, comprise the following:

A user of the Galvanometer Guided Laser Milling process would obtain a copy of the Galvanometer Guided Laser Milling Software and a Galvanometer Guided Laser Milling Machine. The user would install the software to his/her computer and connect the machine to his/her computer. The user would then open the software and import an STL file of a digital model of patient dentition. The user would wait for the software to automatically repair the model and create digital overlay. The user then would select the margin for model trimming and export STL design file to the Galvanometer Guided Laser Milling Machine. The user would then load a blank appliance build material disk to the machine and initialize the machine. The machine would laser cut the material to the specifications of the design .stl file. The user would then remove the finished appliance from the machine.

The above process provides the following advantages over the prior art:

1. Direct manufacture of end use product;

2. Eliminates use of expensive polymers used in direct use additive manufacturing;

3. Eliminates unnecessary step of model making as required in most traditional dental appliance manufacture;

4. Uses a novel manufacturing method not traditionally used for direct manufacture of dental appliances;

5. Less cost;

6. Ease of use;

7. Improved product durability;

8. Improved product quality;

9. Improved strength over traditional thermoplastic appliance use materials;

10. Greatly simplifies process;

11. Eliminates expensive software;

12. Makes appliance manufacture available in-office for dentists;

13. Eliminates staff costs for traditional method trained lab tech/dental assistants;

14. Makes routine retainer design and construction simpler process;

15. Significantly faster process vs traditional model/thermoplastic process; and

16. Significantly faster milling time vs 3D printing.

### BRIEF DESCRIPTION OF THE DRAWINGS

FIG. 1 shows a flow chart of the functions performed by the software.

FIG. 2 shows the creation of a cut plain by the software.

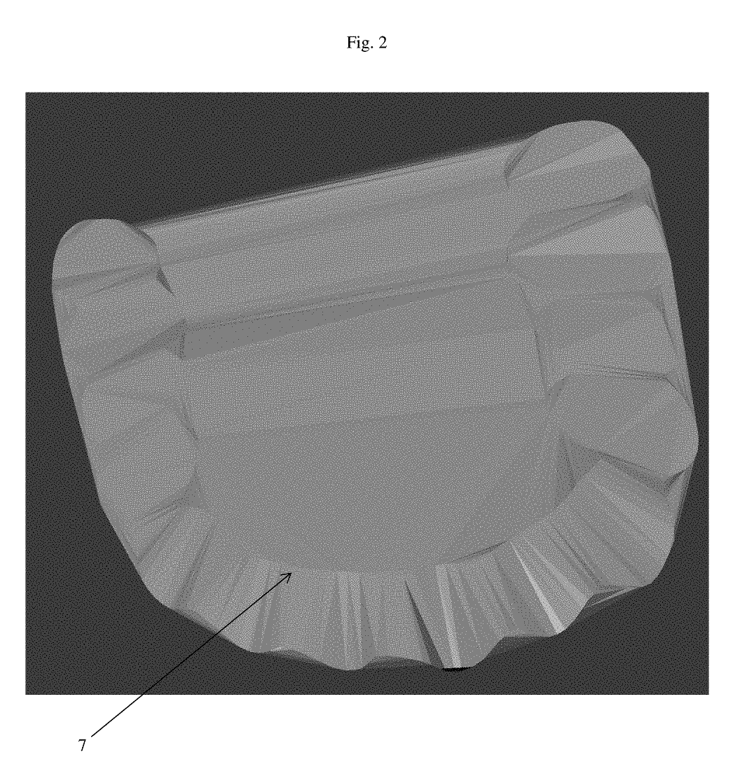

FIG. 3 is a virtual image of a digital model generated by an initial .stl file generated from a scan.

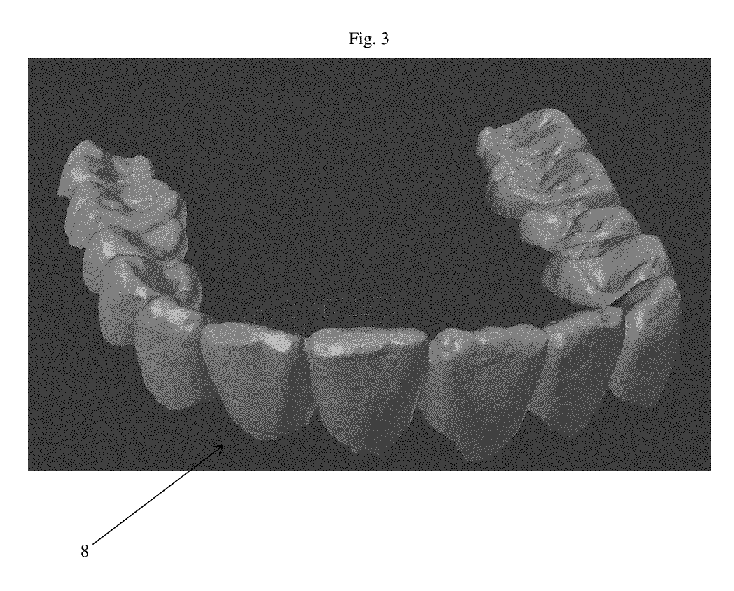

FIG. 4 shows modifications from the reduction of curvature process in repairing the initial .stl file or modifying a surface re-topography of the initial .stl file.

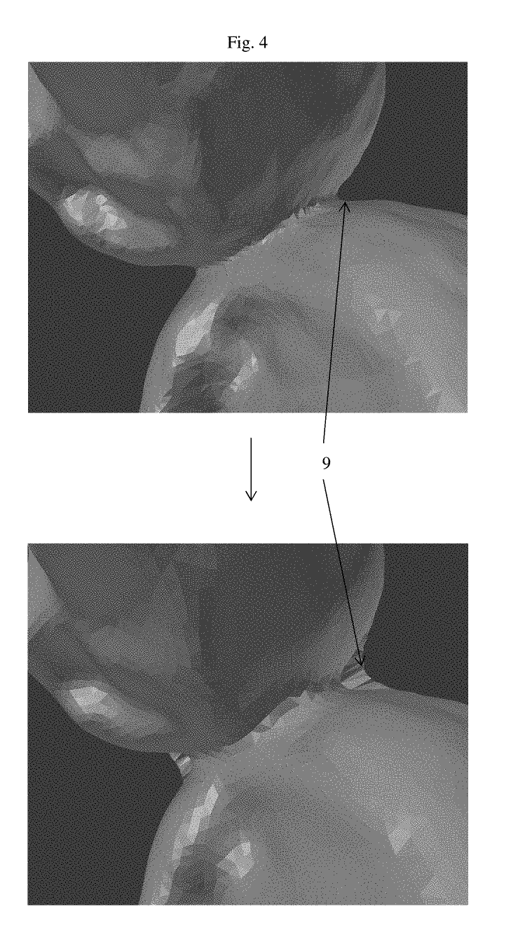

FIG. 5 shows modifications from the gap closing process in repairing the initial .stl file or modifying a surface re-topography of the initial .stl file.

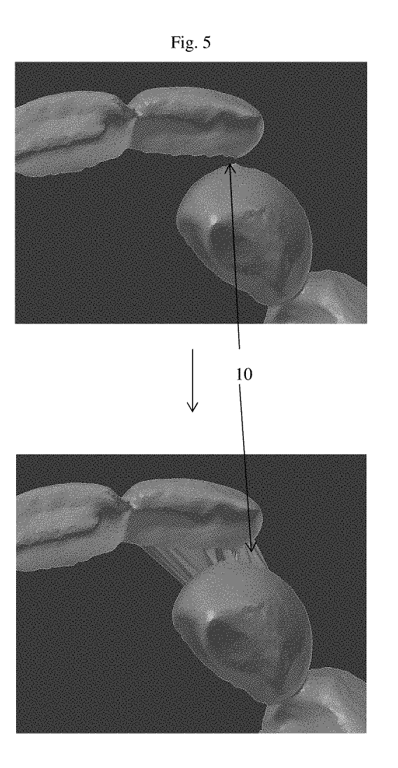

FIG. 6 shows modifications from the outer surface smoothing process in repairing the initial .stl file or modifying a surface re-topography of the initial .stl file.

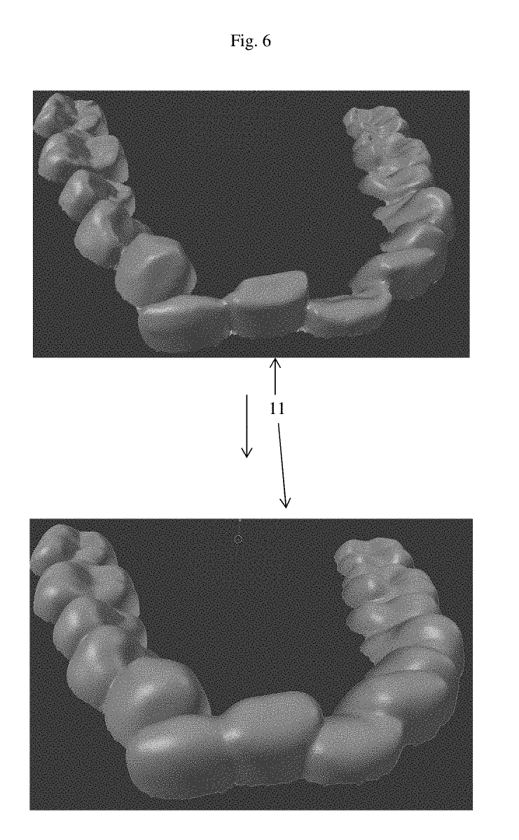

FIG. 7 shows modifications from the inner surface smoothing process in repairing the initial .stl file of the initial or modifying a surface re-topography .stl file.

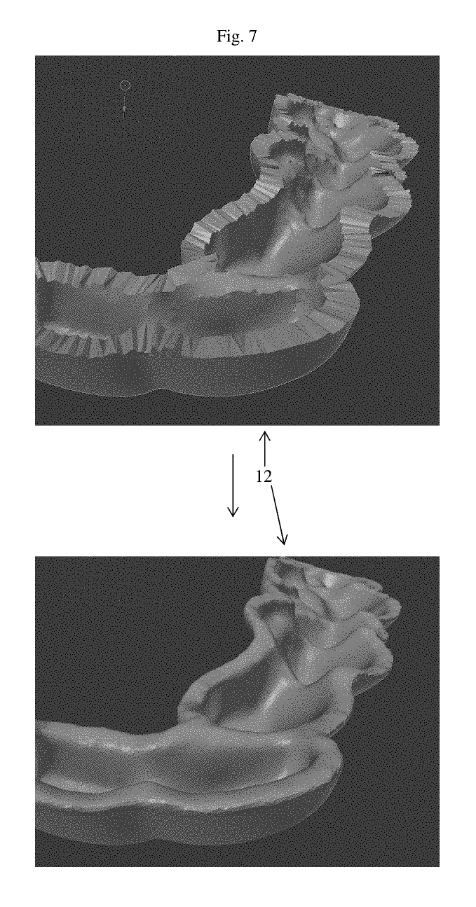

### DETAIL DESCRIPTION OF THE DRAWINGS

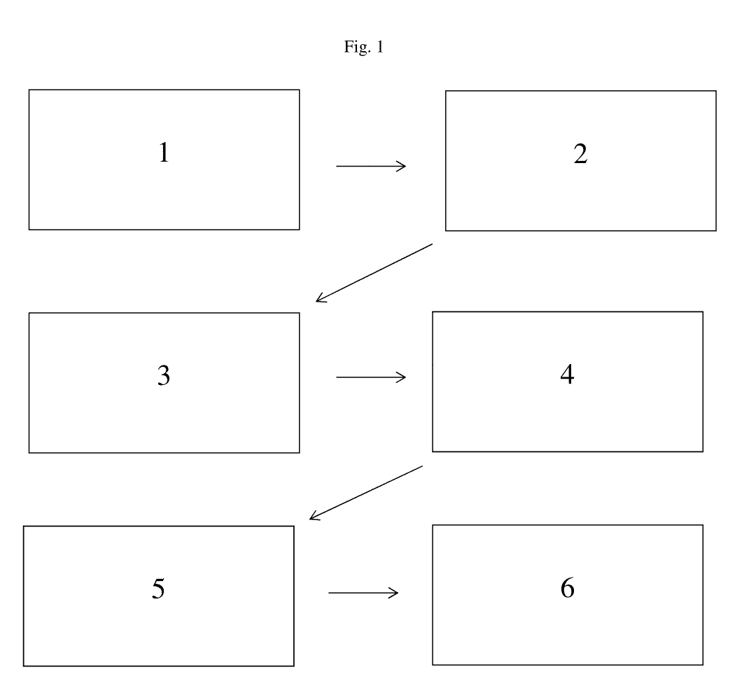

FIG. 1 shows a flow chart of the functions performed by the software. Box 1 is creation of a cut plane 7 by the software. The cut plane 7 is a margin, defined by the user, that specifies the outline of the retainer mesh. This uses user input to create a plane with which to cut the scan mesh. Box 2 is the process of loading a scan STL 8. The scan STL 8 is the digital scan of the patient's teeth that is uploaded into the software. This digital impression is a scan mesh which is what the dental device e.g., retainer mesh, is meant to securely fit on top of. Using the cut plane 7 only the top part of the scan SLT 8 is read in. Additionally, the resulting scan mesh is repaired. Box 3 is a process which reduces the curvature by smoothing out concave curves 9 of the scan mesh so the retainer is not too close to the teeth. Box 4 is a gap closing process which finds spaces 10 between parts of the scan mesh and joins them to form a single continuous scan mesh. Box 5 is a process for smoothing the outer surface by smoothing, remeshing, and fattening the outer surface 11 of the scan mesh. Box 6 is a process for smoothing the inner surface 12 of the scan mesh by connecting boundaries and then remeshing and smoothing the result.

The result of the process shown in box 1-5 is a modified STL file of a scan mesh which can be provided directly to any Additive or Subtractive Dental Device Manufacturing Machine which includes, for example, Galvanometer Guided Laser Milling, a 3D printer, a CNC milling machine, or other similar device to directly created a finished dental device. That is, no model is needed, the dental device can be directly created without a model.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

We claim:

1. A method comprising:
obtaining a scan STL of a patients teeth in the form of an initial .stl file,
repairing the initial .stl file by removing unwanted scan data and repairing surface discrepancies to obtain a repaired .stl file,
translating the repaired .stl file and adding a thickness and perimeter to create a surface re-topography .stl file, which defines an overlay;
modifying the surface re-topography .stl file to modify the perimeter and/or reduce surface undercuts of the overlay, and
exporting the modified surface re-topography .stl file to a device which produces 3D articles from .stl files.

2. The method of claim 1 wherein
repairing the initial .stl file/modifying the surface re-topography .stl file additionally, comprises:
reducing the curvature of the scan mesh by smoothing out concave curves of the scan mesh.

3. The method of claim 2 wherein
repairing the initial .stl file/modifying the surface re-topography .stl file additionally, comprises:
closing gaps in the scan mesh by joining the closest none touching sections to form a single continuous scan mesh.

4. The method of claim 1 wherein
repairing the initial .stl file/modifying the surface re-topography .stl file additionally, comprises:
smoothing the outer surface of the scan mesh by smoothing, remeshing, or fattening the outer surface of the scan mesh.

5. The method of claim 1 wherein
repairing the initial .stl file/modifying the surface re-topography .stl file additionally, comprises:
smoothing the inner surface of the scan mesh by connecting boundaries of the scan mesh and then remeshing or smoothing the result.

6. The method of claim 1 wherein a thickness of from 0.1 mm to 3 mm is selected for the surface re-topography .stl file.

7. The method of claim 6 wherein the thickness selected is 0.3 mm.

8. The method of claim 1, additionally comprising displaying the surface re-topography .stl file as an overlay on top of a model of the patients teeth on a computer screen.

9. The method of claim 1 wherein the surface re-topography .stl file is exported to an additive or subtractive dental device manufacturing machine.

10. The method of claim 9 additionally comprising:
directly producing a dental device with said additive or subtractive dental device manufacturing machine.

11. A method for producing a dental appliance comprising:
receiving a digital scan of an area of a patients mouth in need of treatment,
generating a cut plane for a scan mesh generated from the digital scan of an area of a patients mouth in need of treatment,
modifying the cut plane by smoothing both the inner and outer surfaces of the scan mesh and closing any gaps in the scan mesh,
exporting the scan mesh to an additive or subtractive dental device manufacturing machine, and
producing the dental appliance.

12. The method of claim 11 wherein a thickness of from 0.1 mm to 3.0 mm is selected for the scan mesh.

13. The method of claim 12 wherein the thickness selected is 0.3 mm.

14. The method of claim 11, additionally comprising displaying the scan mesh as an overlay on top of a model of the patients teeth on a computer screen.

15. A dental device made by the process of claim 10.
